(19) United States
(12) Patent Application Publication
(10) Pub. No.: US 2023/0261532 A1
(43) Pub. Date: Aug. 17, 2023

(54) MOTOR AND METHOD FOR MANUFACTURING THE SAME

(71) Applicant: Nidec Corporation, Kyoto (JP)

(72) Inventors: Shinji TAKEMOTO, Kyoto (JP); Tsuyoshi HIROKAWA, Kyoto (JP)

(21) Appl. No.: 18/109,901

(22) Filed: Feb. 15, 2023

(30) Foreign Application Priority Data
Feb. 17, 2022 (JP) 2022-022996

(51) Int. Cl. H02K 1/14; H02K 5/04; H02K 21/16; H02K 15/02

(52) U.S. Cl. CPC H02K 1/148; H02K 5/04; H02K 15/022; H02K 21/16

(57) ABSTRACT

A motor includes a rotor and a stator. The rotor is rotatable about an axially extending central axis. The stator includes a stator core radially opposing the rotor. The stator core includes core back pieces and a teeth portion. The core back pieces are arranged circumferentially about the central axis. The teeth portion extends radially. The core back pieces which are circumferentially adjacent to each other are connected circumferentially via an end on a side of the core back pieces in a radial direction of the teeth portion.

### CROSS-REFERENCE TO RELATED APPLICATIONS

The present application claims priority under 35 U.S.C. §119 to Japanese Patent Application No. 2022-022996, filed on Feb. 17, 2022, the entire contents of which are hereby incorporated herein by reference.

### 1. FIELD OF THE INVENTION

The present disclosure relates to a motor and a method for manufacturing the same.

### 2. BACKGROUND

Conventionally, a motor having a stator core in which teeth are fixed to an annular core back is known. For example, an inner surface of a tubular stator yoke is provided with a recess groove, and a protrusion of a teeth portion is arranged in the recess groove. Then, these structures are fixed by resin molding.

However, when a core back on the radially outer side of the teeth becomes thin, the strength of the core back is liable to decrease, and therefore it is necessary to sufficiently secure the radial thickness of the core back on the radially outer side of the teeth. Therefore, the diameter size of the stator core tends to be large. As described above, when the radially inner surface of the annular core back is provided with a recess, there is a portion where the core back becomes thin near the recess, and therefore the shape of the core back viewed from an axial direction becomes easily distorted from a perfect circle shape. On the other hand, when the portion where the core back becomes thin near the recess is thickened, the diameter size of the stator core is further increased.

### SUMMARY

An example embodiment of a motor of the present disclosure includes a rotor and a stator. The rotor is rotatable about a central axis extending axially. The stator includes a stator core radially opposing the rotor. The stator core includes core back pieces and a teeth portion. The core back pieces are arranged circumferentially about the central axis. The teeth portion extends radially. Core back pieces which are circumferentially adjacent to each other are connected circumferentially via an end on a side of the core back pieces in a radial direction of the teeth portion.

An example embodiment of a method for manufacturing a motor of the present disclosure is a method for manufacturing the motor described above, and includes a connection step. In the connection step, the core back pieces which are circumferentially adjacent to each other are circumferentially connected via the end on the side of the core back pieces in the radial direction of the teeth portion.

The above and other elements, features, steps, characteristics and advantages of the present disclosure will become more apparent from the following detailed description of the example embodiments with reference to the attached drawings.

### BRIEF DESCRIPTION OF THE DRAWINGS

FIG. 1 is a sectional view showing a configuration example of a motor according to an example embodiment of the present disclosure.

FIG. 2 is a sectional view showing a configuration example of a main portion of a stator core according to an example embodiment.

FIG. 3 is a sectional view showing another configuration example of the main portion of the stator core according to the example embodiment.

FIG. 4 is a flowchart to explain an example of a method for manufacturing the motor according to an example embodiment of the present disclosure.

FIG. 5A is a view showing an arrangement example of a coil portion according to an example embodiment of the present disclosure.

FIG. 5B is a view showing a configuration example of the stator core before connection of a connection portion.

FIG. 5C is a view showing a configuration example of the stator core after connection of the connection portion.

FIG. 6 is a sectional view showing a configuration example of the main portion of a stator core according to a first modification of an example embodiment of the present disclosure.

FIG. 7 is a sectional view showing a configuration example of the main portion of a stator core according to a second modification of an example embodiment of the present disclosure.

FIG. 8 is a sectional view showing a configuration example of a tubular portion according to a third modification of an example embodiment of the present disclosure.

### DETAILED DESCRIPTION

Example embodiments of the present disclosure will be described below with reference to the drawings.

In the present description, a direction parallel to a central axis J is referred to as “axial”. A direction orthogonal to the central axis J is referred to as “radial”, and a rotation direction about the central axis J is referred to as “circumferential”. Of the radial direction, an orientation approaching the central axis J is referred to as “radially inward”, and a direction away from the central axis J is referred to as “radially outward”.

In an optional constituent element, an orientation from a central part toward an end of the constituent element in a predetermined direction is referred to as “outward in the predetermined direction”, and an orientation from the end toward the central part of the constituent element in the predetermined direction is referred to as “inward in the predetermined direction”. For example, an orientation from a central part toward an end of an optional constituent element in a circumferential direction is referred to as “circumferentially outward”, and an orientation from the end toward the central part of the optional constituent element in the circumferential direction is referred to as “circumferentially inward”.

In the present description, the “annular” includes a shape seamlessly continuous over the entire region in the circumferential direction about the central axis J and a shape having one or more seams in a part of the entire region about the central axis J. The “annular” also includes a shape in which a closed curve is drawn in a curved surface intersecting the central axis J about the central axis J.

In a positional relationship between any one of the azimuth, line, and plane and another one of them, the term “parallel” includes not only a state in which they do not intersect even if they extend endlessly but also a state in which they are substantially parallel. The terms “perpendicular” and “orthogonal” include not only a state in which both of them intersect each other at 90 degrees but also a state in which they are substantially perpendicular and a state in which they are substantially orthogonal. That is, the terms “parallel”, “perpendicular”, and “orthogonal” each include a state in which the positional relationship between them has an angular deviation that does not depart from the gist of the present disclosure.

Note that, these terms are names used merely for description, and are not intended to limit actual positional relationships, directions, names, and the like.

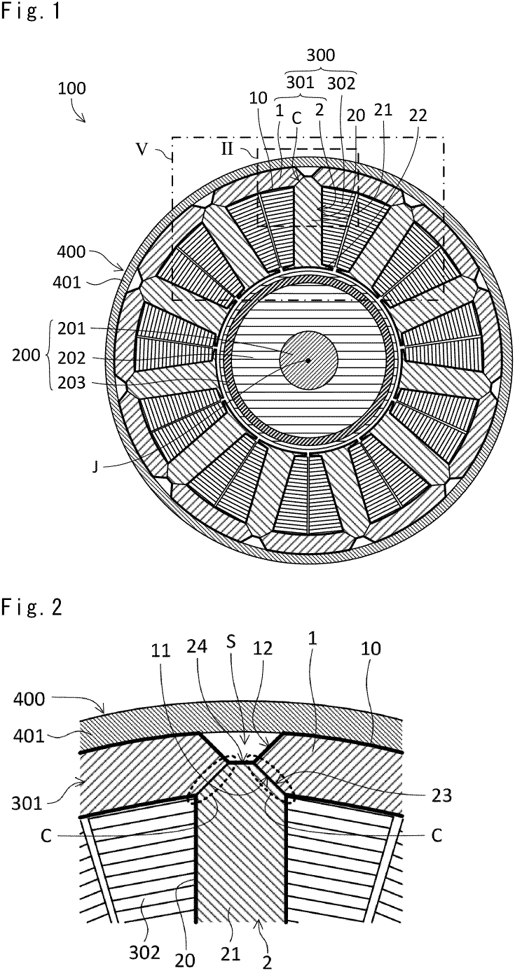

FIG. 1 is a sectional view of a motor 100. FIG. 1 shows a sectional structure of the motor 100 in which a core back piece 1, a teeth portion 2, and the like, which will be described below, are cut on a virtual plane expanding in a direction perpendicular to the central axis J.

As shown in FIG. 1, the motor 100 includes a rotor 200, a stator 300, and a housing 400.

The rotor 200 is rotatable about the central axis J extending axially. As described above, the motor 100 includes the rotor 200. The rotor 200 includes a shaft 201, a rotor core 202, and a magnet 203.

The shaft 201 has a cylindrical shape and extends axially along the central axis J.

The rotor core 202 is fixed to the radially outer end of the shaft 201 and extends axially around the shaft 201. The rotor core 202 is formed using a magnetic material and functions as a yoke of the magnet 203. In the present example embodiment, the rotor core 202 is a laminate in which annular electromagnetic steel plates extending radially are laminated axially.

The magnet 203 is arranged in a radially outer end of the rotor core 202. In the magnet 203, magnetic poles (N pole and S pole) different from each other are alternately arranged circumferentially. The magnet 203 may be an annular member surrounding the central axis J, or may be configured to include a plurality of magnet pieces arranged circumferentially.

The stator 300 includes a stator core 301. As described above, the motor 100 includes the stator 300. The stator core 301 radially opposes the rotor 200. In the present example embodiment, the stator 300 is arranged radially outward relative to the rotor 200.

The stator 300 further includes a plurality of coil portions 302. The coil portion 302 is a member in which a conductive wire (not illustrated) is molded, and the coil portion 302 is arranged in the stator core 301. More specifically, the coil portion 302 is arranged in the teeth portion 2. The conductive wire is, for example, an enamel-coated copper wire, a metal wire coated with an insulating member, or the like. When a drive current is supplied to the coil portion 302, the stator 300 is excited to drive the rotor 200.

The housing 400 accommodates at least a part of the rotor 200 and at least a part of the stator 300. As described above, the motor 100 includes the housing 400. The housing 400 has a tubular portion 401. The tubular portion 401 is arranged radially outward relative to the stator 300 and extends axially. The tubular portion 401 is a tubular body surrounding the rotor 200 and the stator 300. The stator core 301 is held on the radially inner surface of the tubular portion 401.

Next, the configuration of the stator core 301 will be described with reference to FIGS. 1 and 2. FIG. 2 is a sectional view showing the configuration of a main portion of the stator core 301. FIG. 2 is an enlarged view of a portion II surrounded by the broken line in FIG. 1.

The stator core 301 includes a plurality of the core back pieces 1 arranged circumferentially about the central axis J and teeth portion 2 extending radially. The core back pieces 1 each extend circumferentially, are arranged annularly surrounding the central axis J, and are fixed to the radially inner surface of the tubular portion 401. The core back pieces 1 circumferentially adjacent to each other are arranged circumferentially at intervals. Each of the core back piece 1 and the teeth portion 2 is made of a magnetic material, and is a laminate in which electromagnetic steel plates are laminated axially in the present example embodiment. The core back pieces 1 circumferentially adjacent to each other are connected circumferentially via an end on the side of the core back pieces 1 in the radial direction of the teeth portion 2. For example, the part surrounded by the broken line in FIG. 2 indicates a connection portion C between the two.

For example, as compared with the configuration in which radially extending teeth are connected to a radial side surface of an annular core back, in the present example embodiment, by configuring the stator core 301 as described above, it is possible to narrow the interval between the radially outer end of the core back piece 1 and the end on the core back piece 1 side in the radial direction of the teeth portion 2. Therefore, the stator core 301 can be downsized. Hence, the diameter size of the stator 300 can be further reduced, and the motor 100 can be downsized.

It is possible to suppress a decrease in the strength of the stator core 301 as compared with a configuration in which a radially inner side of an annular core back is provided with a recess that is radially recessed to connect a radial end of teeth to the recess. More specifically, by providing the annular core back with the recess, the radial thickness in the region on the radially outer side of the recess in the core back becomes smaller than that in the region not provided with the recess. Therefore, by eliminating the region where the radial thickness becomes thin and circumferentially arranging the plurality of core back pieces 1, there is no longer region where the strength is weak, and therefore it is possible to suppress a decrease in the strength of the stator core 301.

For example, as compared with the configuration in which radially extending teeth are connected to a radial side surface of an annular core back, the plurality of core back pieces 1 can be annularly arranged with higher accuracy. Specifically, in a case of the former annular core back, since the radial side surface of the core back is pushed radially by the teeth, the shape of the core back viewed from the axial direction is easily distorted from a perfect circle shape. On the other hand, in the present example embodiment, for example, by connecting one of the core back piece 1 and the teeth portion 2 in a state where the other is fixed, it is possible to connect the core back piece 1 and the teeth portion 2 without shifting the arrangement positions of the core back piece 1 and the teeth portion 2. Therefore, the plurality of core back pieces 1 can be arranged in an annular shape closer to a perfect circle. Therefore, it is possible to downsize the stator core 301 while suppressing distortion. For example, the shape of the stator core 301 as viewed from the axial direction can be made closer to a circular shape. Therefore, the magnetic flux density distribution in the stator 300 can be more evenly formed in the circumferential direction.

The teeth portion 2 includes a column part 21 and an umbrella part 22. The column part 21 is a columnar body extending radially. In the present example embodiment, the radially outer end of the column part 21 is connected between the core back pieces 1 circumferentially adjacent to each other. The column part 21 extends radially inward from between the core back pieces 1 circumferentially adjacent to each other. The coil portion 302 is arranged on the column part 21. The coil portion 302 is an air core coil 3 inserted into the column part 21. However, the present disclosure is not limited to this example, and the coil portion 302 may be arranged on the column part 21 by winding a conductive wire on the column part 21. The umbrella part 22 extends from the radially inner end of the column part 21 to both circumferential sides. The radially inner end of the column part 21 and the umbrella part 22 radially oppose the rotor 200.

The stator core 301 further includes an insulating coating layer 10 covering the surface of the core back piece 1 and an insulating coating layer 20 covering the surface of the teeth portion 2. That is, the insulating coating layers 10 and 20 made of an electrically insulating material are arranged on the surfaces of the core back piece 1 and the teeth portion 2. In the present example embodiment, a fluororesin is used for the insulating coating layers 10 and 20. However, the present disclosure is not limited to this example, and an electrically insulating resin other than a fluororesin, ceramics, and the like can be used for the insulating coating layers 10 and 20. This makes it possible to secure electrical insulation between the coil portion 302 arranged in the stator core 301 and the core back piece 1 and the teeth portion 2. For example, by arranging the insulating coating layer 10 on the core back piece 1, it is possible to more reliably insulate the coil portion 302 and the core back piece 1 from each other. By arranging the insulating coating layer 10 on the teeth portion 2, it is possible to more reliably insulate the coil portion 302 and the teeth portion 2 from each other.

In the present example embodiment, the insulating coating layers 10 and 20 are thin films. However, this example does not exclude a configuration in which at least one of both is not the above-described thin film. For example, at least one of both may be a coating film or may include a surface treatment layer of the core back piece 1 and the teeth portion 2.

Next, the core back piece 1 includes a first connection surface 11 expanding in a direction obliquely intersecting the radial direction. The first connection surface 11 is arranged in the circumferential end of the core back piece 1 and expands radially inward toward circumferentially inward. In the present example embodiment, the first connection surface 11 is a plane parallel to the axial direction, and is arranged at both circumferential ends of the core back piece 1. For example, the first connection surface 11 arranged at one circumferential end of the core back piece 1 expands radially inward toward the circumferential other direction. Similarly, the first connection surface 11 arranged at the other circumferential end of the core back piece 1 expands radially inward toward one circumferential direction.

The teeth portion 2 further includes a second connection surface 23 expanding in a direction obliquely intersecting the radial direction. The second connection surface 23 is arranged in the end on the core back piece 1 side in the radial direction of the teeth portion 2. The second connection surface 23 is connected to the first connection surface 11 of the core back piece 1. The second connection surface 23 is parallel to the first connection surface 11 and expands radially outward toward circumferentially inward. The second connection surface 23 constitutes the connection portion C together with the first connection surface 11. In the present example embodiment, the second connection surface 23 is a plane parallel to the axial direction, and is arranged on both circumferential sides of the radially outer end of the column part 21. For example, the second connection surface 23 arranged on one circumferential side of the radially outer end of the column part 21 expands radially outward toward the other circumferential side. Similarly, the second connection surface 23 arranged on the other circumferential side of the radially outer end of the column part 21 expands radially outward toward the one circumferential side.

In the connection portion C, the first connection surface 11 and the second connection surface 23 are connected by laser welding in the present example embodiment. However, the connection means between both is not limited to this example. The both may be connected by means other than laser welding, or may be connected by bonding means such as brazing.

In the connection portion C, the first connection surface 11 and the second connection surface 23 expand in the direction obliquely intersecting the radial direction, so that the connection area between the core back piece 1 and the teeth portion 2 can be further increased. Therefore, the stress applied to the connection portion C of the both can be dispersed over a wider connection area. Therefore, the strength of the stator core 301 can be improved.

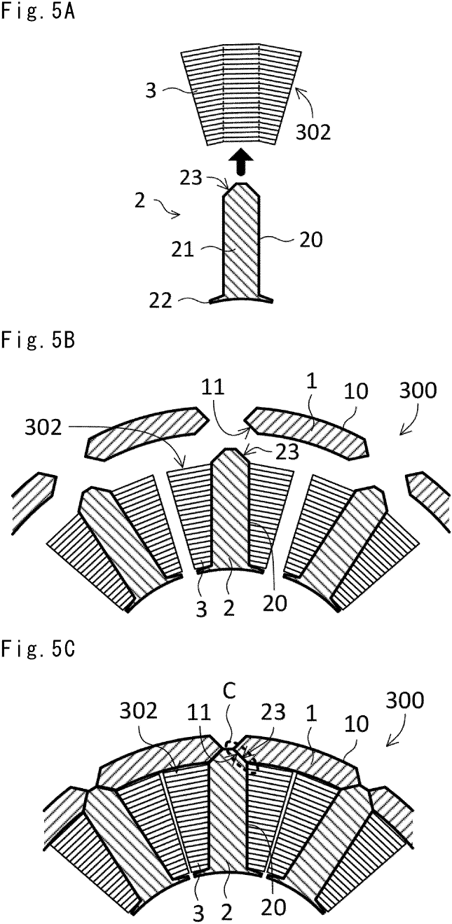

By arranging the second connection surface 23 as described above in the end on the core back piece 1 side in the radial direction of the teeth portion 2, the circumferential width of the end of the teeth portion 2 described above can be narrowed toward the core back piece 1 when viewed from the axial direction. Therefore, for example, when arranging the air core coil 3 in the teeth portion 2 (see, for example, FIG. 5A described below), it is possible to easily insert the air core coil 3 without damaging the air core coil 3 (in particular, the insulation film of the conductive wire).

However, the above-described example does not exclude a configuration in which the expansion direction of the first connection surface 11 and the second connection surface 23 is not a direction obliquely intersecting the radial direction. For example, the first connection surface 11 and the second connection surface 23 may be planes parallel to the radial direction or planes perpendicular to the radial direction.

Next, on the radially outer surface of the stator core 301, an outer edge (for example, a radially outer end) of the connection portion C between the core back piece 1 and the teeth portion 2 is exposed to the outside of the stator core 301. On an axial end face of the stator core 301, the outer edge (for example, the axial end) of the connection portion C between the core back piece 1 and the teeth portion 2 is exposed to the outside of the stator core 301. This makes it possible to connect the core back piece 1 and the teeth portion 2 from the outside of the stator core 301 (for example, from the radially outer side). Therefore, the both can be easily connected.

The core back piece 1 further includes an inclined surface 12. The inclined surface 12 expands radially outward toward circumferentially inward from the circumferential end of the core back piece 1. The inclined surface 12 is arranged radially outward relative to the first connection surface 11 in the circumferential end of the core back piece 1 on which the first connection surface 11 is arranged. In the present example embodiment, the inclined surfaces 12 are arranged on both circumferential sides of all the core back pieces 1. For example, the inclined surface 12 arranged in one circumferential end of the core back piece 1 expands radially outward toward the other circumferential side. Similarly, the inclined surface 12 arranged in the other circumferential end of the core back piece 1 expands radially outward toward the one circumferential side. However, the present disclosure is not limited to this example, and in at least one core back piece 1, the inclined surface 12 may be arranged only on one circumferential side of the core back piece 1. Preferably, the inclined surface 12 is arranged on at least one of the circumferential ends of the core back pieces 1 circumferentially adjacent to each other. Specifically, the inclined surface 12 is arranged at least at one of the other circumferential end of the core back piece 1 on one circumferential side and the one circumferential end of the core back piece 1 on the other circumferential side.

This makes it possible to, even if a burr or the like occurs in the radially outer end of the connection portion C between the core back piece 1 and the teeth portion 2, make the burr spread in the vicinity of the connection portion C, and thus suppress the burr from extending radially outward relative to the core back piece 1. Therefore, the burr can be prevented from hitting another member (for example, the tubular portion 401).

Since it is possible to secure a wider work space for connecting the core back pieces 1 adjacent to each other via the teeth portion 2, it is possible to improve the workability.

However, the above-described example does not exclude a configuration in which the inclined surface 12 is not arranged on at least one core back piece 1.

Preferably, at least a part of the end on the core back piece 1 side in the radial direction of the teeth portion 2 is exposed to the outside of the stator core 301. Specifically, at least one teeth portion 2 further includes an exposed surface 24. The exposed surface 24 is arranged in the radially outer end of the column part 21 and radially opposes a radially inner surface of the tubular portion 401. In the present example embodiment, the exposed surface 24 is arranged between the two second connection surfaces 23 in the radially outer end of the column part 21. The circumferential end of the exposed surface 24 is connected to the radially outer end of the second connection surface 23. This makes it possible to secure a wider work space for connecting the core back piece 1 and the teeth portion 2, and therefore it is possible to improve the workability at the time of connecting the core back piece 1 and the teeth portion 2.

Preferably, at least a part of the end on the core back piece 1 side in the radial direction of the teeth portion 2 radially opposes the tubular portion 401 with a gap S. For example, as shown in FIG. 2, the exposed surface 24 radially opposes the radially inner surface of the tubular portion 401 with the gap S. Due to this, the outer edge of the connection portion C between the core back piece 1 and the teeth portion 2 exposed to the outside of the stator core 301 is radially separated from the tubular portion 401, and is therefore not in contact with the radially inner surface of the tubular portion 401. Therefore, even if the outer edge is rough, the stator core 301 can be easily inserted and arranged in the tubular portion 401.

However, the above-described example does not exclude a configuration in which there is no gap S between the end on the core back piece 1 side in the radial direction of the teeth portion 2 and the tubular portion 401. For example, the exposed surface 24 may be in contact with the radially inner surface of the tubular portion 401.

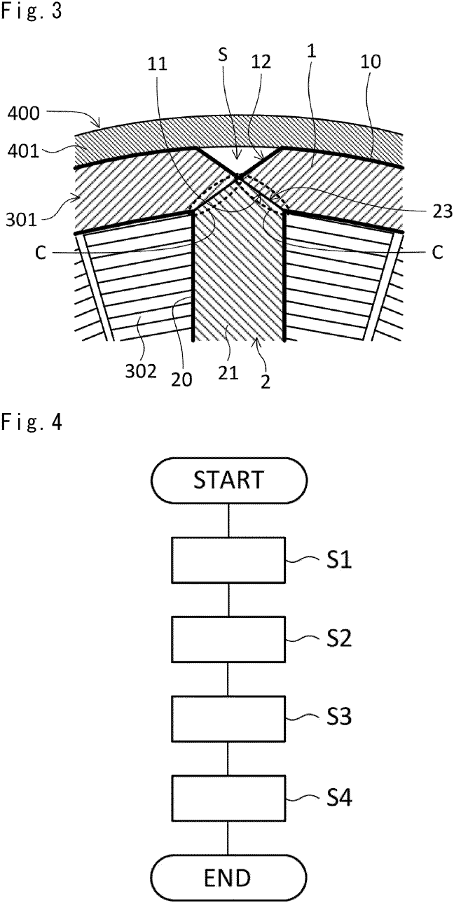

The above-described example does not exclude a configuration in which the end on the core back piece 1 side in the radial direction of the teeth portion 2 is not exposed to the outside of the stator core 301. For example, at least one teeth portion 2 needs not have the exposed surface 24. In other words, in at least one of the core back pieces 1 circumferentially adjacent to each other, the circumferential ends of the core back pieces 1 circumferentially adjacent to each other may be in contact with each other in the circumferential direction as shown in FIG. 3. Specifically, of the core back pieces 1 circumferentially adjacent to each other, the other circumferential end of the core back piece 1 on one circumferential side may be in contact with the one circumferential end of the core back piece 1 on the other circumferential side. Thus, for example, as shown in FIG. 3, the core back pieces 1 circumferentially adjacent to each other can be circumferentially connected to each other by means of welding, bonding, or the like. Therefore, it is possible to improve the strength of the stator core 301 between the core back pieces 1 circumferentially adjacent to each other. Even when water droplets or the like enter the inside of the motor, it is possible to suppress water from adhering to the teeth portion 2 on the radially outer surface of the stator core 301. Therefore, it is possible to prevent generation of rust, corrosion, and the like on the teeth portion 2 (particularly, the radially outer end of the connection portion C) due to adhesion of water. Therefore, deterioration in performance of the motor 100 can be suppressed.

Next, a method for manufacturing the motor 100 will be described with reference to FIGS. 4 to 5C. FIG. 4 is a flowchart for explaining an example of the method for manufacturing the motor 100. FIG. 5A shows an arrangement example of the coil portion 302. FIG. 5B shows a configuration example of the stator core 301 before the connection of the connection portion C. FIG. 5C shows a configuration example of the stator core 301 after the connection of the connection portion C. In FIG. 5A, the teeth portion 2 and the air core coil 3 are viewed from the axial direction. FIGS. 5B and 5C correspond to a part V surrounded by the one-dot chain line in FIG. 1.

First, the insulating coating layer 10 is arranged on each core back piece 1, and the insulating coating layer 20 is arranged on each teeth portion 2 (step S1). In each core back piece 1, the insulating coating layer 10 covers the entire surface of the core back pieces 1 in the present example embodiment, but may cover a part of the surface. For example, the insulating coating layer 10 may cover only a region of the surface of the core back piece 1 with which the coil portion 302 is in contact after formation of the connection portion C. Similarly, in each teeth portion 2, the insulating coating layer 20 covers the entire surface of the teeth portion 2 in the present example embodiment, but may cover a part of the surface. For example, the insulating coating layer 20 may cover only a region of the surface of the teeth portion 2 with which the coil portion 302 is in contact after formation of the connection portion C.

The coil portion 302 is arranged in each teeth portion 2 (step S2). For example, as shown in FIG. 5A, the teeth portion 2 is inserted into the air core coil 3.

The core back pieces 1 circumferentially adjacent to each other are connected circumferentially via an end on the side of the core back pieces 1 in the radial direction of the teeth portion 2 (step S3). For example, as shown in FIG. 5B, the plurality of core back pieces 1 are arranged along the circumferential direction, and the radially outer end of the teeth portion 2 is arranged between the core back pieces 1 circumferentially adjacent to each other. Then, as shown in FIG. 5C, the second connection surface 23 of the teeth portion 2 overlaps and comes into contact with the first connection surface 11 of the core back piece 1, and both are laser welded from the outer edge thereof.

The stator 300 is formed by the above steps S1 to S3.

Next, the rotor 200 and the stator 300 are accommodated inside the housing 400, and the stator 300 is fixed to the radially inner surface of the tubular portion 401 (step S4). Then, the process of FIG. 4 ends.

According to the above-described process, the method for manufacturing the motor 100 of the present example embodiment includes a connection step S3 of circumferentially connecting the core back pieces 1 circumferentially adjacent to each other via an end on the side of the core back pieces 1 in the radial direction of the teeth portion 2.

Thus, for example, as compared with the configuration in which radially extending teeth are connected to a radial side surface of an annular core back, it is possible to narrow the interval between the radially outer end of the core back piece 1 and the end on the core back piece 1 side in the radial direction of the teeth portion 2. Therefore, the stator core 301 can be downsized. Hence, the diameter size of the stator 300 can be further reduced, and the motor 100 can be downsized.

It is possible to suppress a decrease in the strength of the stator core 301 as compared with a configuration in which a radially inner side of an annular core back is provided with a recess that is radially recessed to connect a radial end of teeth to the recess. More specifically, by providing the annular core back with the recess, the radial thickness in the region on the radially outer side of the recess in the core back becomes smaller than that in the region not provided with the recess. Therefore, by eliminating the region where the radial thickness becomes thin and circumferentially arranging the plurality of core back pieces 1, there is no longer region where the strength is weak, and therefore it is possible to suppress a decrease in the strength of the stator core 301.

For example, as compared with the configuration in which radially extending teeth are connected to a radial side surface of an annular core back, the plurality of core back pieces 1 can be annularly arranged with higher accuracy. For example, by connecting one of the core back piece 1 and the teeth portion 2 in a state where the other is fixed, it is possible to connect the core back piece 1 and the teeth portion 2 without shifting the arrangement positions of the core back piece 1 and the teeth portion 2. Therefore, the plurality of core back pieces 1 can be arranged in an annular shape closer to a perfect circle. Therefore, it is possible to downsize the stator core 301 while suppressing distortion. For example, the shape of the stator core 301 viewed from the axial direction can be made closer to a perfect circle. Therefore, the magnetic flux density distribution in the stator 300 can be more evenly formed in the circumferential direction.

The above-described process is a method for manufacturing the motor 100 including the coil portion 302 arranged in the stator core 301, and further includes an insertion step S2 of inserting the teeth portion 2 into the air core coil 3. In the connection step S3, the core back pieces 1 circumferentially adjacent to each other are connected circumferentially via the end on the core back piece 1 side in the radial direction of the teeth portion 2 through which the air core coil 3 is inserted.

Due to this, the stator core 301 is formed after the air core coil 3 molded in advance is inserted into the teeth portion 2, and therefore the coil portion 302 can be easily and quickly arranged in the stator core 301. Consequently, productivity of the motor 100 is improved.

The present disclosure is not limited to the above example, and the coil portion 302 may be arranged in the teeth portion 2 by winding a conductive wire around the column part 21 as described above. In this case, the arrangement of the coil portion 302 is performed after the connection step S3.

In the above-described process, in the connection step S3, the core back piece 1 and the teeth portion 2 are coated in advance with the insulating coating layers 10 and 20, respectively, which are formed using an electrically insulating material.

This makes it possible to form the stator core 301 by connecting the core back piece 1 and the teeth portion 2 coated with the insulating coating layers 10 and 20 in advance. That is, an insulator for electrically insulating the stator core 301 and the coil portion 302 needs not be arranged after the formation of the stator core 301. Therefore, the stator 300 can be formed by a simple method.

Next, first to third modifications of the example embodiment will be described. Hereinafter, configurations different from those of the above-described example embodiment will be described regarding the first to third modifications. Constituent elements similar to those in the above example embodiment and other modifications are denoted by the same reference numerals, and detailed description thereof will be omitted. The example embodiment and the first to third modifications thereof can be implemented in combination with one another within a range where no particular contradiction occurs.

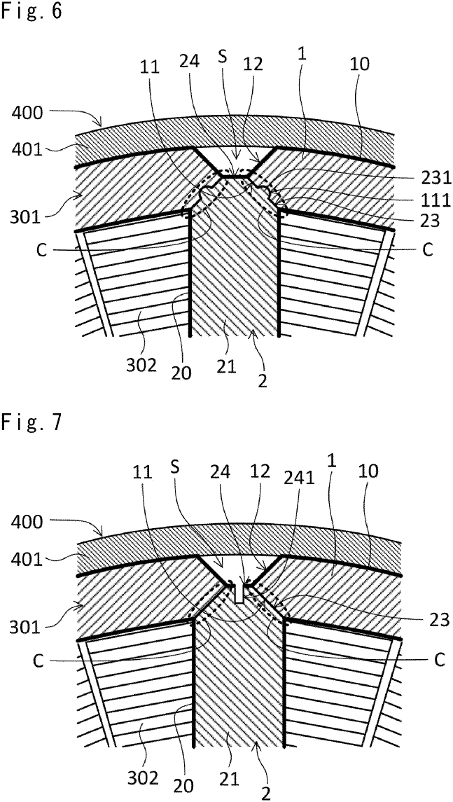

FIG. 6 is a sectional view showing a configuration example of a main portion of the stator core 301 according to the first modification. FIG. 6 corresponds to the portion II surrounded by the broken line in FIG. 1.

In FIG. 6, at least one core back piece 1 further includes a recess 111. The recess 111 is arranged on the first connection surface 11 and is recessed in a direction from the second connection surface 23 toward the first connection surface 11. The teeth portion 2 connected to the above-described core back piece 1 including the recess 111 further includes a protrusion 231. The protrusion 231 is arranged on the second connection surface 23 and protrudes in a direction from the second connection surface 23 toward the first connection surface 11.

The arrangement of the recess 111 and the protrusion 231 may be opposite to that in FIG. 6. That is, in at least one core back piece 1, the protrusion 231 may be arranged on the first connection surface 11. In this case, the protrusion 231 protrudes in a direction from the first connection surface 11 toward the second connection surface 23. The recess 111 may be arranged on the second connection surface 23 of the teeth portion 2 connected to the above-described core back piece 1 including the protrusion 231. In this case, the recess 111 is recessed in a direction from the first connection surface 11 toward the second connection surface 23.

As described above, in the first modification, the recess 111 is arranged on one surface of the first connection surface 11 and the second connection surface 23. The recess 111 is recessed from the other surface of the first connection surface 11 and the second connection surface 23 toward the above-described one surface. The recess 111 is an example of a “first recess” of the present disclosure. The protrusion 231 is arranged on the other surface described above. The protrusion 231 protrudes from the above-described other surface toward the above-described one surface and is arranged in the recess 111. This makes it possible to facilitate positioning of the core back piece 1 and the teeth portion 2 due to the fitting structure of the recess 111 and the protrusion 231 when the core back piece 1 and the teeth portion 2 are connected to each other.

FIG. 7 is a sectional view showing a configuration example of a main portion of the stator core 301 according to the second modification. FIG. 7 corresponds to the portion II surrounded by the broken line in FIG. 1.

In the second modification, the teeth portion 2 include a recess 241. The recess 241 is an example of a “third recess” of the present disclosure, and is arranged between the circumferential ends of the core back pieces 1 circumferentially adjacent to each other. In FIG. 7, the recess 241 is arranged on the exposed surface 24. The recess 241 is recessed radially from the end on the core back piece 1 side in the radial direction of the teeth portion 2 and opens to the outside of the stator core 301. The recess 241 may be a single hole or a plurality of holes arranged axially side by side. Alternatively, the recess 241 may be an axially extending groove.

According to the second modification, when connecting the core back piece 1 and the teeth portion 2, by attaching a jig to the recess 241, it is possible to accurately position the arrangement position of the teeth portion 2 in the circumferential direction. Therefore, the stator core 301 can be formed annularly with high accuracy.

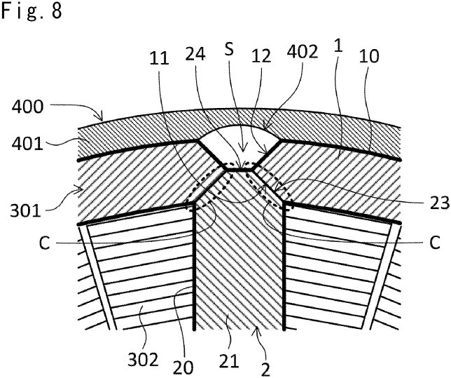

FIG. 8 is a sectional view showing a configuration example of the tubular portion 401 according to the third modification. FIG. 8 corresponds to the portion II surrounded by the broken line in FIG. 1.

In the third modification, the housing 400 further includes a recess 402. The recess 402 is an example of a “second recess” in the present disclosure, and is arranged on the radially inner surface of the tubular portion 401. The recess 402 is recessed radially outward and opens in the radial direction toward between the core back pieces 1 circumferentially adjacent to each other. The recess 402 may be singular or plural. Each of the recesses 402 is arranged at a position radially opposing the radially outer end of at least one teeth portion 2.

Due to this, the outer edge of the connection portion C between the core back piece 1 and the teeth portion 2 exposed to the outside of the stator core 301 is formed between the core back pieces 1 circumferentially adjacent to each other, and therefore radially opposes the recess 402. Therefore, the above-described outer edge does not come into contact with the radially inner surface of the tubular portion 401. Therefore, even if the above-described outer edge is rough, the stator core 301 can be easily inserted and arranged in the tubular portion 401.

The example embodiment of the present disclosure and the first to third modifications thereof have been described above. The scope of the present disclosure is not limited to the above-described example embodiment. The present disclosure can be implemented by adding various modifications to the above-described example embodiment and the first to third modifications thereof without departing from the gist of the disclosure. The matters described in the above-described example embodiment and the first to third modifications thereof can be appropriately and optionally combined as long as no contradiction occurs.

The present disclosure is useful for a motor in which a coil portion is arranged on teeth extending radially from a core back.

Features of the above-described example embodiments and the modifications thereof may be combined appropriately as long as no conflict arises.

While example embodiments of the present disclosure have been described above, it is to be understood that variations and modifications will be apparent to those skilled in the art without departing from the scope and spirit of the present disclosure. The scope of the present disclosure, therefore, is to be determined solely by the following claims.

What is claimed is:

1. A motor comprising:
a rotor rotatable about a central axis extending axially; and
a stator including a stator core radially opposing the rotor; wherein
the stator core includes:
core back pieces arranged circumferentially about the central axis; and
a teeth portion extending radially; and
the core back pieces which are circumferentially adjacent to each other are connected circumferentially via an end on a side of the core back pieces in a radial direction of the teeth portion.

2. The motor according to claim 1, wherein
the core back pieces include a first connection surface on a circumferential end of the core back piece;
the teeth portion includes a second connection surface in the end on the side of the core back pieces in the radial direction of the teeth portion and connected to the first connection surface; and
the first connection surface and the second connection surface expand in a direction obliquely intersecting a radial direction.

3. The motor according to claim 2, wherein
the core back pieces further include an inclined surface expanding radially outward from the circumferential end of the core back pieces toward circumferential inward; and
the inclined surface is located radially outward relative to the first connection surface in the circumferential end of one of the core back pieces on which the first connection surface is located.

4. The motor according to claim 2, wherein
one surface of the first connection surface and the second connection surface is provided with a first recess recessed toward the one surface from another surface of the first connection surface and the second connection surface; and
the other surface is provided with a protrusion protruding toward the one surface from the other surface and arranged in the first recess.

5. The motor according to claim 1, wherein an outer edge of a connection portion between the core back pieces and the teeth portion is exposed to an outside of the stator core on a radially outer surface of the stator core.

6. The motor according to claim 1, wherein
the core back pieces which are circumferentially adjacent to each other are arranged circumferentially at intervals; and
at least a portion of the end on the side of the core back pieces in the radial direction of the teeth portion is exposed to an outside of the stator core.

7. The motor according to claim 1, wherein circumferential ends of the core back pieces which are circumferentially adjacent to each other circumferentially come into contact with each other.

8. The motor according to claim 1, further comprising:
a housing that accommodates at least a portion of the rotor and at least a portion of the stator; wherein
the housing includes a tubular portion arranged radially outward relative to the stator and extends axially;
the stator core is held in a radially inner end of the tubular portion; and
at least a portion of the end on the side of the core back pieces in the radial direction of the teeth portion radially opposes the tubular portion with a gap.

9. The motor according to claim 8, wherein
the housing includes a second recess on a radially inner surface of the tubular portion and recessed radially outward; and
the second recess opens in a radial direction toward a space between the core back pieces which are circumferentially adjacent to each other.

10. The motor according to claim 1, wherein
the teeth portion includes a third recess between circumferential ends of the ones of the core back pieces which are circumferentially adjacent to each other; and
the third recess is recessed in the radial direction from the end on the side of the core back pieces in the radial direction of the teeth portion.

11. The motor according to claim 1, wherein an insulating coating layer made of an electrically insulating material is provided on surfaces of the core back piece and the teeth portion.

12. A method for manufacturing the motor according to claim 1, the method comprising:
circumferentially connecting the core back pieces which are circumferentially adjacent to each other via the end on the side of the core back pieces in the radial direction of the teeth portion.

13. The method for manufacturing the motor according to claim 12, the motor including a coil portion in the stator core, the method further comprising:
an insertion step of inserting the teeth portion into an air core coil; wherein
when circumferentially connecting the core back pieces which are circumferentially adjacent to each other, the core back pieces which are circumferentially adjacent to each other are connected circumferentially via the end on the side of the core back pieces in the radial direction of the teeth portion through which the air core coil is inserted.

14. The method for manufacturing the motor according to claim 12, wherein
when circumferentially connecting the core back pieces which are circumferentially adjacent to each other, the core back pieces and the teeth portion are each coated in advance with insulating coating formed using an electrically insulating material.

15. The motor according to claim 3, wherein
one surface of the first connection surface and the second connection surface is provided with a first recess recessed toward the one surface from another surface of the first connection surface and the second connection surface; and
the other surface is provided with a protrusion protruding toward the one surface from the other surface and located in the first recess.

16. The motor according to claim 2, wherein an outer edge of a connection portion between the core back pieces and the teeth portion is exposed to an outside of the stator core on a radially outer surface of the stator core.

17. The motor according to claim 3, wherein an outer edge of a connection portion between the core back pieces and the teeth portion is exposed to an outside of the stator core on a radially outer surface of the stator core.

18. The motor according to claim 4, wherein an outer edge of a connection portion between the core back pieces and the teeth portion is exposed to an outside of the stator core on a radially outer surface of the stator core.

19. The motor according to claim 2, wherein
the core back pieces circumferentially adjacent to each other are arranged circumferentially at intervals; and
at least a portion of the end on the side of the core back pieces in the radial direction of the teeth portion is exposed to an outside of the stator core.

20. The motor according to claim 3, wherein
the core back pieces which are circumferentially adjacent to each other, are arranged circumferentially at intervals; and
at least a portion of the end on the side of the core back pieces in the radial direction of the teeth portion is exposed to an outside of the stator core.
